(19) United States
(12) Patent Application Publication
(10) Pub. No.: US 2025/0078017 A1
(43) Pub. Date: Mar. 6, 2025

(54) PREDICTIVE TRACKING MANAGEMENT SYSTEM

(71) Applicant: FourKites, Inc., Chicago, IL (US)

(72) Inventor: James Lee, Chicago, IL (US)

(73) Assignee: FourKites, Inc., Chicago, IL (US)

(21) Appl. No.: 18/818,346

(22) Filed: Aug. 28, 2024

Related U.S. Application Data
(60) Provisional application No. 63/580,212, filed on Sep. 1, 2023.

(51) Int. Cl. G06Q 10/0833; G06Q 10/0635; G06Q 10/087

(52) U.S. Cl. CPC G06Q 10/0833; G06Q 10/0635; G06Q 10/087

(57) ABSTRACT

Disclosed are systems, apparatuses, methods, and computer-readable media for predicting delays in carrier shipping services. A method includes: obtaining stock information from an inventory management system of a customer, wherein the stock information includes identification of products stocked at different locations; obtaining shipment information from a shipment management system, the shipment information including sources of the products stocked at different location and tracking information for the products from the sources; and providing a user interface comprising the stock information, shipment information, environmental impact information, and shipment performance information into a single view based on an operation view or an executive summary view.

### TECHNICAL FIELD

The present disclosure generally relates to tracking management systems. In some examples, aspects of the present disclosure are related to a predictive tracking management system.

### BACKGROUND

Shippers who import from various suppliers often use pre-defined commercial terms or International Commercial Terms (Incoterms) that instruct the suppliers to make carriage bookings. Unfortunately, in many cases, when a carriage booking is made, the shipper may not have visibility into the shipment or may have partial or incomplete visibility into the shipment. For example, in many cases, the supplier may not provide the booking data to the shipper after making a carriage booking. Without the booking data, the shipper may lack at least some visibility into the shipment. Such incomplete or lack of visibility into the shipment may cause gaps or inaccuracies in the supply chain visibility and/or limit or complicate the shipper's ability to track and/or process certain aspects of the shipment and provide customers accurate and/or detailed tracking and visibility of the shipment. Moreover, these factors are generally not under the control of the shipper and, as previously explained, may negatively affect the shipper's ability to accurately and/or consistently track shipments and/or provide visibility information.

### SUMMARY

In some examples, systems and techniques are described for predicting delays in carrier shipping services. The systems and techniques can visibility and identification of issues in potential shipments in carrier shipping services.

According to at least one example, a method is provided for tracking shipments (use preamble). The method includes: obtaining, from a mobile computing device, a shipment information associated with a booking of a load and asset information corresponding to a physical asset associated with transport of the load; identifying one or more sources of location data for the physical asset based on the asset information; and generating tracking information for the load by associating the one or more sources of location data for the physical asset with the shipment information associated with the booking of the load.

In another example, an apparatus for tracking shipments is provided that includes at least one memory and at least one processor coupled to the at least one memory. The at least one processor is configured to: obtain, from a mobile computing device, a shipment information associated with a booking of a load and asset information corresponding to a physical asset associated with transport of the load; identify one or more sources of location data for the physical asset based on the asset information; and generate tracking information for the load by associating the one or more sources of location data for the physical asset with the shipment information associated with the booking of the load.

In another example, a non-transitory computer-readable medium is provided that has stored thereon instructions that, when executed by one or more processors, cause the one or more processors to: obtain, from a mobile computing device, a shipment information associated with a booking of a load and asset information corresponding to a physical asset associated with transport of the load; identify one or more sources of location data for the physical asset based on the asset information; and generate tracking information for the load by associating the one or more sources of location data for the physical asset with the shipment information associated with the booking of the load.

In another example, an apparatus for tracking shipments is provided. The apparatus includes: means for obtaining, from a mobile computing device, shipment information associated with a booking of a load and asset information corresponding to a physical asset associated with transport of the load; means for identifying one or more sources of location data for the physical asset based on the asset information; and means for generating tracking information for the load by associating the one or more sources of location data for the physical asset with the shipment information associated with the booking of the load.

In some aspects, one or more of the apparatuses described herein is, is part of, and/or includes a mobile device (e.g., a mobile telephone and/or mobile handset and/or so-called “smartphone” or other mobile device), an extended reality (XR) device (e.g., a virtual reality (VR) device, an augmented reality (AR) device, or a mixed reality (MR) device), a head-mounted device (HMD) device, a vehicle or a computing system, device, or component of a vehicle, a wearable device (e.g., a network-connected watch or other wearable device), a wireless communication device, a camera, a personal computer, a laptop computer, a server computer, another device, or a combination thereof. In some aspects, the apparatus includes a camera or multiple cameras for capturing one or more images. In some aspects, the apparatus further includes a display for displaying one or more images, notifications, and/or other displayable data. In some aspects, the apparatuses described above can include one or more sensors (e.g., one or more inertial measurement units (IMUs), such as one or more gyroscopes, one or more gyrometers, one or more accelerometers, any combination thereof, and/or other sensors).

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

In order to describe the manner in which the various advantages and features of the disclosure can be obtained, a more particular description of the principles described herein will be rendered by reference to specific embodiments thereof which are illustrated in the appended drawings. Understanding that these drawings depict only example embodiments of the disclosure and are not to be considered to limit its scope, the principles herein are described and explained with additional specificity and detail through the use of the drawings in which:

FIG. 1 is conceptual illustration of an example shipment management system, in accordance with some aspects of the disclosure;

FIG. 2 is a block diagram illustrating an example shipment management system, in accordance with some aspects of the disclosure;

FIG. 3A is an example illustration of a user interface that surfaces different modes of supply chain information to enable identification of missed efficiencies, costs, delays, and other logistics in accordance with some aspects of the disclosure;

FIG. 3B is an example of a user interface for operations overview of a shipment management system in accordance with some aspects of the disclosure;

FIG. 4 is an example of a user interface that surfaces different services provided by a shipment management system in accordance with some aspects of the disclosure;

FIG. 5 is a flow diagram of a method for a predictive tracking management system, in accordance with some examples;

FIG. 6 illustrates an example computing device architecture, in accordance with some examples of the present disclosure.

### DETAILED DESCRIPTION

Certain aspects of this disclosure are provided below. Some of these aspects may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and descriptions are not intended to be restrictive.

The ensuing description provides example aspects only and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the spirit and scope of the application as set forth in the appended claims.

The terms “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

There are many aspects of various commerce management systems that are separated by various barriers. As an example, shipment management systems are decoupled from inventory management systems and information decoupling creates barriers for operations. The inability to have a wholesome view of an operation creates lost opportunities.

In another aspect, the disclosure includes a method comprising: obtaining, from a mobile computing device, a shipment information associated with a booking of a load and asset information corresponding to a physical asset associated with transport of the load; identifying one or more sources of location data for the physical asset based on the asset information; and generating tracking information for the load by associating the one or more sources of location data for the physical asset with the shipment information associated with the booking of the load. Thus, in some aspects, it is the QR code or other information may function to associate the asset information and the location data for the physical asset.

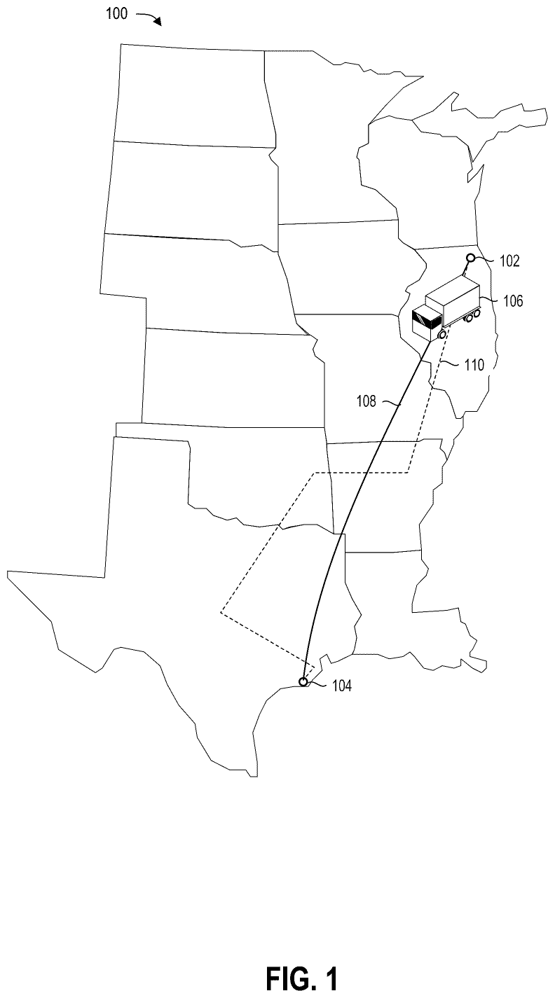

FIG. 1 is conceptual illustration of an example shipment, in accordance with some aspects of the disclosure. In some aspects, an originator of a load (e.g., a shipment) contracts with a consigning party, or a carrier service, to transport the load from an originating location 102 to a destination location 104. However, the carrier service may contract out the consignment of the load to a third-party service 106. In some cases, the third-party service 106 can be a different carrier service or may be individuals having a load transportation vehicle, such as a tractor-trailer.

In some cases, when a carrier separately engages the third-party service 106 to handle the shipment of the load, information pertaining to the shipment of the load may be unavailable. For example, an electronic logging device (ELD) may track a location of the load using global positioning system (GPS) and cellular networks, but because the third-party service 106 is not registered within a shipment system that is configured to track the shipment 100, the movement of the load cannot be monitored. For example, a brokered shipment (e.g., a load) may be unable to be tracked as the carrier contracts the shipment to handle the carrier's responsibilities. In some cases, the shipment may be time-sensitive and being unable to identify a location of the third-party service 106 carrying the load can lead to issues. For example, in aspect illustrated FIG. 1, the load is intended to be delivered to a port in connection with an international shipment and arrival of the load at the port is critical for various purposes. For example, if the load arrives within a specific period, the load can be directly loaded onto the ship without requiring an intermediary storage within the shipment yard. In some aspects, directly loading the shipment can increase confidence in the shipment and ensures that the shipment does not experience inadvertent delays.

In this case, the third-party service can take a direct route 108, but the direct route assumes there are no other third-party consignees. In some cases, the third-party service 106 proceeds on route 110 instead of direct route 108 due to various considerations such as weather, traffic, other priorities, additional shipments, etc. In the event that the third-party service 106 brokers the shipment, an originator of the load may have no visibility into the progress of the load. Visibility into the shipment's progress may be critical to surfacing that any remediation actions should an intervening event cause a potential delay.

Various other delays can be incurred and reduce supply chain logistics and efficiencies. For example, a dwell time at a shipping terminal (e.g., an airplane shipping facility, a port, etc.) and delays at the port and caused miss efficiencies. To this end, the foregoing synthesizes different types of information from varying sources to surface inefficiencies, missed opportunities, and other pertinent information to improve operations and supply chain logistics.

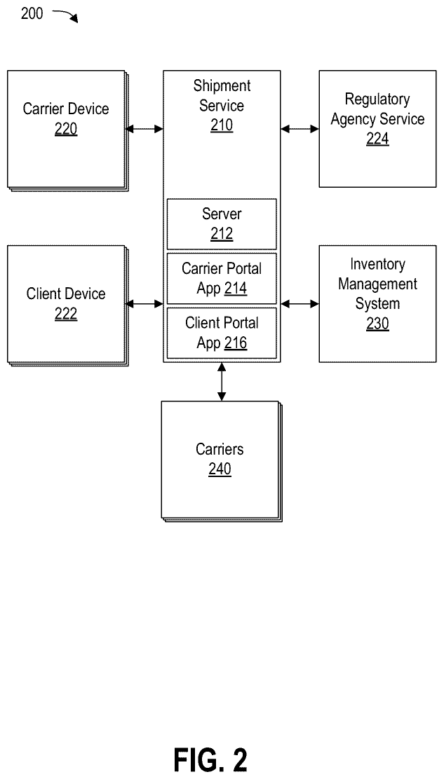

FIG. 2 is a block diagram illustrating an example shipment management system 200 in accordance with some aspects of the disclosure. According to aspects of the disclosure, the shipment management system 200 comprises a shipment service 210 that is configured to engage carriers that can have at least one carrier device 220, clients 222, third-party services 224, and at least one regulatory service 226 to enable seamless end-to-end shipment tracking irrespective of the actual carrier of the shipment. The example shipment management system 200 may also be configured to interact with an inventory management system 230 and a plurality of carriers 240.

In some aspects, the shipment service 210 includes a server 212 that is configured to deliver a plurality of applications such as a carrier portal application 214 and a client portal application 216. In some aspects, the carrier portal application 214 enables a seamless registration process when a carrier or a third-party service (e.g., the third-party service 106) contracting with the carrier to retrieve a load for shipment from an origination location to a destination location.

In one illustrative aspect, the carrier portal application 214 is configured to be delivered to carrier device 220 when the operator associated with the carrier enters or exits a shipment facility (e.g., an originating location). In this case, the carrier portal application 214 can be executed by the shipment service 210 or on the carrier device 220, such as a mobile computing device of the carrier or a mobile computing device of an operator (e.g., a driver). The operator uses the carrier device 220 to enter asset information, which can include a truck identifier and a trailer identifier, and the carrier device 220 sends the asset information to the shipment service 210. In response to the asset information, the shipment service 210 can execute various functionality in the server 212 to search for information stored in a repository (not shown) or other data storage device or service to retrieve information related to the assets. In some cases, the trailer identifier can be associated with an ELD, which can be used to then be used to associate a truck with a load. For example, an operator of the carrier may be required to provide the asset information when entering a shipping origination facility, which can be used to link the load (e.g., a shipment) with the carrier.

In some aspects, the shipment service 210 can be configured to communicate with a service 226 associated with a regulatory agency to connect various information from the regulatory agency. In some cases, the ELD is required to be registered with the USDOT and may be configured to provide location and/or other tracking location information from the ELD in real-time or near real-time (e.g., delayed information). In one illustrative aspect, when the shipment service 210 receives the asset information, the server 212 may include logic to surface information from the third-party services 224 to identify the tracking information of the carrier. In this case, when the carrier enters the shipping facility to retrieve the load, the operator uses the carrier portal application 214 to enter information that can be linked to the tracking information to enable real-time or near real-time tracking information which can allow a consignor (e.g., a shipper) to monitor load transit.

The client portal application 216 may be a separate application that is provided to a client device that allows monitoring of the carrier and the load while in transit. As described above, shipment service 210 associates the ELD of the vehicle carrying the load with information in the shipment service 210, allowing the shipment service 210 to provide transit information to various clients.

As noted above, the shipment management system 200 can link multiple modes on information using regulatory information. This can also extend to other regulatory agencies, such a customs and border patrol to identify optimum routes for scheduling and receiving shipments. In some aspects, the shipment management system 200 can also link to an inventory management system 230 of a customer. The inventory management system 230 may an on-premises system of the customer as well as a cloud-based system. The shipment management system 200 can extract various information to provide economic, scheduling, and other information relevant from the inventory management system 230.

The shipment management system 200 can also link to various carriers 240 to identify information pertinent to the shipments. In some cases, the shipment management system 200 includes predictive ML models that are configured to identify delays of the carriers 240 due to congestion, weather, or other adverse effects. The shipment management system 200 is configured to surface the sum of all the information to provide customers a global view of different aspects of the supply chain logistics and identify inefficiencies.

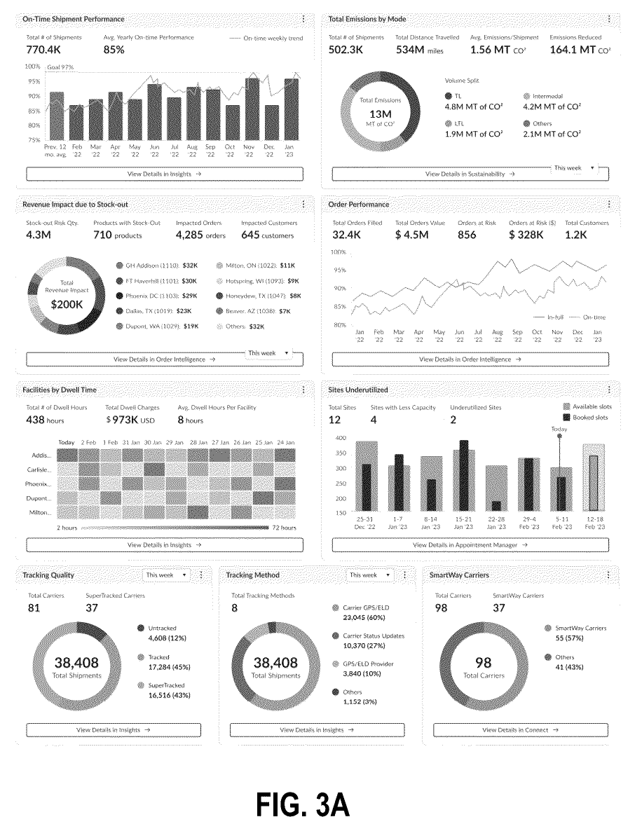

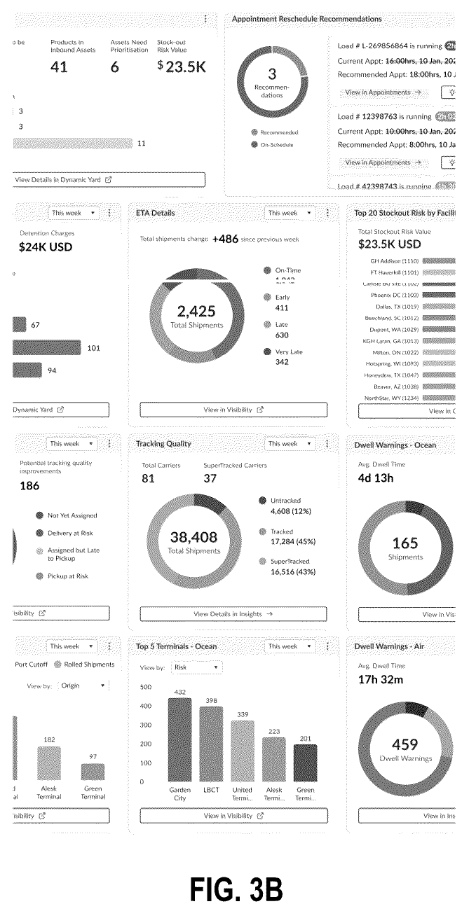

FIG. 3A is an example illustration of a user interface that surfaces different modes of supply chain information to enable identification of missed efficiencies, costs, delays, and other logistics in accordance with some aspects of the disclosure. As shown in FIG. 3A, the shipment performance, environmental impact information, lost revenue, order performance, shipping delays, underutilized facilities (e.g., ports), and other tracking information can be displayed to a user. In some aspects, the information presented to the user is based on authorization to different levels of service. FIG. 3A is an example of an executive overview of the shipment management system 200.

FIG. 3B is an example of a user interface for operations overview of a shipment management system in accordance with some aspects of the disclosure. In this case, a user may be more oriented toward daily operations and may be provided specific information pertaining to daily information. In this case, the user interface includes a scheduling panel that identifies current shipping operations. In some cases, the current shipping operations may be related to predicted delays and other information and may enable the user to engage in various changes. For example, the user interface may allow the user to select a different carrier for a package or shipment due to changed priority of that package or shipment.

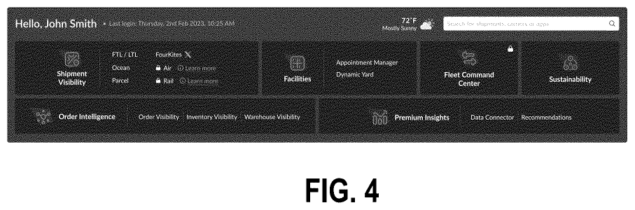

FIG. 4 is an example of a user interface that surfaces different services provided by a shipment management system in accordance with some aspects of the disclosure. As shown in FIG. 4, different aspects associated with the shipment management system can be illustrated in a compact form to identify different services a customer of the shipment management system may request to improve shipment and supply chain performance.

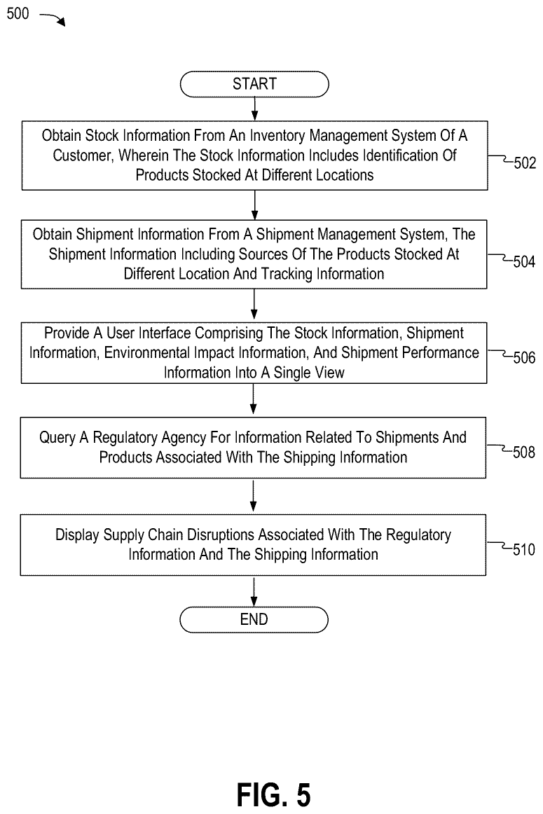

FIG. 5 is a flow diagram of a method for a shipment tracking system, in accordance with some examples. Although the example method 500 depicts a particular sequence of operations, the sequence may be altered without departing from the scope of the present disclosure. For example, some of the operations depicted may be performed in parallel or in a different sequence that does not materially affect the function of the method 500. In other examples, different components of an example device or system that implements the method 500 may perform functions at substantially the same time or in a specific sequence.

At block 502, the computing system may obtain stock information from an inventory management system of a customer. For example, the stock information includes identification of products stocked at different locations.

At block 504, the computing system may obtain shipment information from a shipment management system. For example, the shipment information including sources of the products stocked at different location and tracking information for the products from the sources.

At block 506, the computing system may provide a user interface comprising the stock information, shipment information, environmental impact information, and shipment performance information into a single view based on an operation view or an executive summary view. In some aspects, the user interface may be an online portal displaying a dashboard, such as the user interfaces illustrated in FIG. 3A and FIG. 3B. In one aspect, the user interface includes a dwell panel that identifies durations and costs to due dwelling at a shipment terminal.

In other aspects, the user interface includes a terminal panel that maps usage of a shipment terminal to an operation parameter associated with a shipment. The user interface includes a schedule for upcoming shipments and recommendations for upcoming shipments. The user interface includes a revenue impact due to mapping stock out units based on the stock information and shipment information. The user interface displays a panel for displaying a summary of the environmental impact information based on the shipment information for a duration of time.

In some cases, the computing system may identify at least one shipment or upcoming shipment at risk of being delayed due to congestion. The computing system may display a recommendation associated with the at least one shipment or upcoming shipment on the user interface. For example, in one implementation of block 510, the computing system may

At block 508, the computing system may query a regulatory agency for information related to shipments and products associated with the shipping information.

At block 510, the computing system may display supply chain disruptions associated with the regulatory information and the shipping information.

The computing system can also query a regulatory agency for carrier information based on the asset information, for example, when the shipment service does not recognize the agency identifier. In this case, the carrier information may not correspond to an originating carrier that is provided during the booking of the load. In some cases, the computing system may register the carrier information using information provided by the regulatory agency based on the carrier information being unavailable.

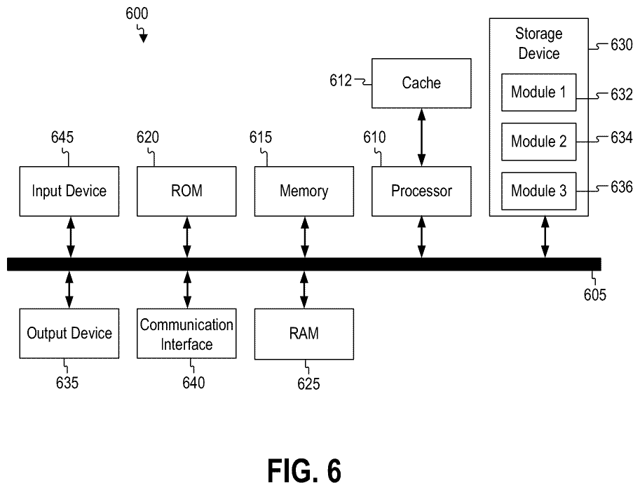

FIG. 6 is a diagram illustrating an example of a system for implementing certain aspects of the present technology. In particular, FIG. 6 illustrates an example of computing system 600, which can be for example any computing device making up an internal computing system, a remote computing system, a camera, or any component thereof in which the components of the system are in communication with each other using connection 605. In some cases, the connection 605 can be a physical connection using a bus, or a direct connection into processor 610, such as in a chipset architecture. The connection 605 can also be a virtual connection, networked connection, or logical connection.

In some aspects, computing system 600 is a distributed system in which the functions described in this disclosure can be distributed within a datacenter, multiple data centers, a peer network, etc. In some aspects, one or more of the described system components represents many such components each performing some or all of the function for which the component is described. In some aspects, the components can be physical or virtual devices.

The example computing system 600 includes at least one processor 610 (e.g., a CPU or processor unit) and connection 605 that couples various system components including system memory 615, such as ROM 620 and RAM 625 to processor 610. The computing system 600 can include a cache 612 of high-speed memory connected directly with, in close proximity to, or integrated as part of the processor 610.

The processor 610 can include any general-purpose processor and a hardware service or software service, such as services 632, 634, and 636 stored in storage device 630, configured to control the processor 610 as well as a special-purpose processor where software instructions are incorporated into the actual processor design. The processor 610 may essentially be a completely self-contained computing system, containing multiple cores or processors, a bus, memory controller, cache, etc. A multi-core processor may be symmetric or asymmetric.

To enable user interaction, the computing system 600 includes an input device 645, which can represent any number of input mechanisms, such as a microphone for speech, a touch-sensitive screen for gesture or graphical input, keyboard, mouse, motion input, speech, etc. The computing system 600 can also include output device 635, which can be one or more of a number of output mechanisms. In some instances, multimodal systems can enable a user to provide multiple types of input/output to communicate with computing system 600. The computing system 600 can include communications interface 640, which can generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a Bluetooth® wireless signal transfer, a BLE wireless signal transfer, an IBEACON® wireless signal transfer, an RFID wireless signal transfer, near-field communications (NFC) wireless signal transfer, dedicated short range communication (DSRC) wireless signal transfer, 802.11 WiFi wireless signal transfer, WLAN signal transfer, Visible Light Communication (VLC), Worldwide Interoperability for Microwave Access (WiMAX), IR communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 640 may also include one or more Global Navigation Satellite System (GNSS) receivers or transceivers that are used to determine a location of the computing system 600 based on receipt of one or more signals from one or more satellites associated with one or more GNSS systems. GNSS systems include, but are not limited to, the US-based GPS, the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

The storage device 630 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, RAM, static RAM (SRAM), dynamic RAM (DRAM), ROM, programmable read-only memory (PROM), erasable programmable read-only memory (EPROM), electrically crasable programmable read-only memory (EEPROM), (flash EPROM (FLASHEPROM), cache memory (L1/L2/L3/L4/L5/L #), resistive random-access memory (RRAM/ReRAM), phase change memory (PCM), spin transfer torque RAM (STT-RAM), another memory chip or cartridge, and/or a combination thereof.

The storage device 630 can include software services, servers, services, etc., that when the code that defines such software is executed by the processor 610, it causes the system to perform a function. In some aspects, a hardware service that performs a particular function can include the software component stored in a computer-readable medium in connection with the necessary hardware components, such as processor 610, connection 605, output device 635, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as CD or DVD, flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some cases, the computing device or apparatus may include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device may include a display, one or more network interfaces configured to communicate and/or receive the data, any combination thereof, and/or other component(s). The one or more network interfaces can be configured to communicate and/or receive wired and/or wireless data, including data according to the 3G, 4G, 5G, and/or other cellular standard, data according to the Wi-Fi (802.11x) standards, data according to the Bluetooth™ standard, data according to the IP standard, and/or other types of data.

The components of the computing device can be implemented in circuitry. For example, the components can include and/or can be implemented using electronic circuits or other electronic hardware, which can include one or more programmable electronic circuits (e.g., microprocessors, GPUs, DSPs, CPUs, and/or other suitable electronic circuits), and/or can include and/or be implemented using computer software, firmware, or any combination thereof, to perform the various operations described herein.

In some aspects the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per sc.

Specific details are provided in the description above to provide a thorough understanding of the aspects and examples provided herein. However, it will be understood by one of ordinary skill in the art that the aspects may be practiced without these specific details. For clarity of explanation, in some instances the present technology may be presented as including individual functional blocks including functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but may have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general-purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc. Examples of computer-readable media that may be used to store instructions, information used, and/or information created during methods according to described examples include magnetic or optical disks, flash memory, USB devices provided with non-volatile memory, networked storage devices, and so on.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices, or other small form factor personal computers, personal digital assistants, rackmount devices, standalone devices, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

The various illustrative logical blocks, modules, circuits, and algorithm steps described in connection with the aspects disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general-purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as RAM such as synchronous dynamic random-access memory (SDRAM), ROM, non-volatile random access memory (NVRAM), EEPROM, flash memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more DSPs, general-purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

What is claimed is:

1. A method comprising:
obtaining stock information from an inventory management system of a customer, wherein the stock information includes identification of products stocked at different locations;
obtaining shipment information from a shipment management system, the shipment information including sources of the products stocked at different location and tracking information for the products from the sources; and
providing a user interface comprising the stock information, shipment information, environmental impact information, and shipment performance information into a single view based on an operation view or an executive summary view.

2. The method of claim 1, wherein one or more of the shipment information and the asset information are obtained using an online portal, the online portal presented in response activating a function when a carrier vehicle associated with the asset information enters into a shipping location.

3. The method of claim 1, wherein the user interface includes a dwell panel that identifies durations and costs to due dwelling at a shipment terminal.

4. The method of claim 1, wherein the user interface includes a terminal panel that maps usage of a shipment terminal to an operation parameter associated with a shipment.

5. The method of claim 1, wherein the user interface includes a schedule for upcoming shipments and recommendations for upcoming shipments.

6. The method of claim 1, wherein the user interface includes a revenue impact due to mapping stock out units based on the stock information and shipment information.

7. The method of claim 1, wherein the user interface displays a panel for displaying a summary of the environmental impact information based on the shipment information for a duration of time.

8. The method of claim 1, further comprising:
identifying at least one shipment or upcoming shipment at risk of being delayed due to congestion; and
displaying a recommendation associated with the at least one shipment or upcoming shipment on the user interface.

9. The method of claim 1, further comprising:
displaying a recommended service associated with lost revenue associated with one delay identified in the shipment information and the stock information.

10. The method of claim 1, further comprising:
querying a regulatory agency for information related to shipments and products associated with the shipping information; and
displaying supply chain disruptions associated with the regulatory information and the shipping information.
